(19) United States
(12) Patent Application Publication
(10) Pub. No.: US 2012/0015131 A1
(43) Pub. Date: Jan. 19, 2012

(54) BAMBOO LUMBER PRODUCTS

(76) Inventors: Ahmet Akarsu, Tokyo (JP); Joseph Ratchford, Red Hook, NY (US); Mayumi Kurisaki, Tokyo (JP)

(21) Appl. No.: 12/838,216

(22) Filed: Jul. 16, 2010

(51) Int. Cl. B32B 5/12; B32B 37/02; B32B 38/04; B32B 21/00

(52) U.S. Cl. 428/54; 428/292.4; 428/114; 156/60; 156/256

(57) ABSTRACT

A building material includes a first segment of a grass; a second segment of the grass; and a first joint element in the first segment that engages with a corresponding second joint element in the second segment, so that the segments form a strip. The grass may be bamboo. A board includes a plurality of bamboo segments, joined together end-to-end with joint elements to form strips; a plurality of strips, attached together to form panels; and a plurality of panels, attached together to form the board. The strips and panels are laminated together with an exterior grade, low formaldehyde, low-urea-content adhesive.

### BACKGROUND OF THE INVENTION

The present invention generally relates to construction and more specifically to bamboo lumber products.

Current bamboo products are made from a “strand-woven” process. Current bamboo products are of short length, usually six feet or less, are highly susceptible to moisture damage, and are usually not suitable for structural use. Bamboo is also very susceptible to mold and mildew growth.

Although bamboo lumber has been readily available (primarily as flooring and plywood), the current processes employed in the manufacture of these products do not permit them to be used for exposed exterior applications. Most available bamboo products are constructed from “strand woven” material, where the bamboo is crushed into strands and mixed with an adhesive solution to create a slurry. The slurry is then heated and pressed into various desired shapes (flooring, etc.) and allowed to cure. The resulting product is suitable for interior use only, as the moisture and temperature variations encountered in an exterior environment cause rapid deterioration of the material. Solid bamboo products that are currently available are limited in length (usually no longer than six feet), due to the nature of the raw material. In addition, bamboo can be highly conducive to the growth of mold and/or mildew, which causes an unsightly appearance, presents a health hazard, and may contribute to delamination of the bamboo strips.

Due to the cellular structure of bamboo, it is highly susceptible to the intrusion of moisture, as the strands of bamboo act as “straws” and the resulting capillary action allows moisture to wick up into the strands. When the ambient humidity is reduced, the moisture will evaporate and the bamboo will dry out. This constant change in moisture content contributes to dimensional instability such as warping, twisting, cupping, and delamination of any products manufactured of bamboo when exposed over time to an outdoor environment.

Raw bamboo has been used as a building material for centuries, and in raw form limits some of these problems, but when prepared for use in a lamination process the mold/mildew and moisture problems are exacerbated due to the removal of the protective outer shell of the bamboo stalks.

The rapid depletion of the world's hardwood forests has created a demand for alternative building materials, and bamboo would be an ideal source, were it not for inherent deficiencies. Bamboo is not only a rapidly-renewable resource, but it will consume three times the carbon dioxide and release twice the amount of oxygen from and into the atmosphere than an equivalent stand of hardwood trees. Additionally, bamboo is not wood, but rather a type of grass. When it is cut it is not destroyed and may be repetitively harvested. Bamboo regenerates for harvesting in three to five years.

It would be desirable to have products constructed of bamboo with enhanced applications, used in a safe and environmentally conscious manner.

### SUMMARY OF THE INVENTION

In one aspect of the present invention, a building material includes a first segment of a grass; a second segment of the grass; and a first joint element in the first segment that engages with a corresponding second joint element in the second segment, so that the segments form a strip.

In another aspect of the present invention, a board includes a plurality of bamboo segments, joined together end-to-end with joint elements to form strips; a plurality of strips, attached together to form panels; and a plurality of panels, attached together to form the board; wherein the strips and panels are laminated together with an exterior grade, low formaldehyde, low-urea-content adhesive.

In yet another aspect of the present invention, a method of making a building material from a grass includes joining segments of the grass together to form a plurality of strips; arranging the strips to achieve a desired dimension; and utilizing laminating the strips together.

### BRIEF DESCRIPTION OF THE DRAWINGS

FIGS. 1A, 1B, and 1C illustrate side views of examples of an embodiment of a bamboo strip according to the present invention;

FIG. 2 illustrates a side view of an example embodiment of a bamboo strip, with the bamboo strips of FIGS. 1A, 1B, and 1C, joined together;

FIG. 3 illustrates a perspective view of an embodiment of a bamboo board with multiple bamboo strips laminated together;

FIGS. 4A through 4H illustrate side views of examples of an embodiment of joints;

FIG. 5 illustrates an embodiment of a single-layer panel where the strips are oriented horizontally;

FIG. 6 illustrates an embodiment of a single-layer panel where the strips are oriented vertically;

FIG. 7 illustrates an embodiment of a multi-layer board with the strips oriented horizontally and all in the same direction;

FIG. 8 illustrates an embodiment of a multi-layer board with the strips oriented horizontally with the strips of each layer alternating in different directions;

FIG. 9 illustrates an embodiment of a multi-layer board with the strips oriented vertically and all in the same direction;

FIG. 10 illustrates an embodiment of a multi-layer board with the strips oriented vertically with the strips of each layer in different directions;

FIG. 11 illustrates an embodiment of a multi-layer board where each layer alternates between horizontal and vertical orientation, horizontal on the outside, with all strips in the same direction;

FIG. 12 illustrates an embodiment of a multi-layer board where each layer alternates between horizontal and vertical orientation, horizontal on the outside, and the strips of each layer in different directions;

FIG. 13 illustrates an embodiment of a multi-layer board where each layer alternates between horizontal and vertical orientation, vertical on the outside, with all strips in the same direction; and

FIG. 14 illustrates an embodiment of a multi-layer board where each layer alternates between horizontal and vertical orientation, vertical on the outside, and the strips of each layer in different directions.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides bamboo lumber products for exterior applications. Embodiments may allow bamboo lumber products to be used in exterior environments while being environmentally safe.

An embodiment of the present invention may include the use of solid laminated bamboo strips (“lamellas”) to create long length structural lumber, decking, panels, posts, rods and other building material suitable for fully-exposed exterior use. Embodiments may use environmentally safe exterior grade adhesive in the lamination process, and include additives such as impregnation of the products with environmentally safe mold and mildew inhibitor, impregnation of the products with an environmentally safe fire retardant or a combination mold, mildew and fire retardant, and the impregnation of the products with, or post-installation application of, an environmentally safe nano technology coating to further protect the products from mold and mildew as well as to inhibit product degradation from exposure to ultraviolet radiation from the sun. The resulting products may be environmentally safe, visually attractive, of high structural strength, suitable for interior or exterior applications, mold and mildew resistant, and manufactured from a rapidly renewable resource.

Embodiments of the present invention may include slicing harvested, kiln-dried bamboo, such as Phyllostachys pubescens (“Moso” bamboo) or other suitable bamboo into continuous, lamellas of uniform thickness, or horizontal plane, and width, or vertical plane (for example ¼″ thick and ¾″ wide) and of 6 feet or more in length.

To achieve the desired product lengths of 30 feet or more, the bamboo lamellas may be joined end-to-end using various joint techniques as illustrated in the drawings. The lamellas may be assembled in variations and laminated together using an exterior grade, low formaldehyde, low-urea-content adhesive in a high-heat and high-pressure process. The manufacturing process may employ a randomizing technique to prevent multiple joints in the lamellas from ending up adjacent to one another, thus assuring increased tensile strength and increased modulus of elasticity by solid, non-jointed lamella sections supporting its jointed neighbor. In embodiments, the lengths of the bamboo segments may differ so that the joint positions are non-adjacent, or so that the joint positions in adjacent strips in a panel do not line up.

Embodiments of the resulting product may be produced in various dimensions, from 6 mm up to several inches of thickness, as well as in varied widths and lengths for use as lumber, decking, flooring, posts, ceiling panels, siding and any other applications normally employing hardwood or composite lumber.

After cutting to the desired dimensions, a finish-sanding step may assure that the smooth and visually attractive properties of the bamboo are visible.

Embodiments of the product may be impregnated by pressure-injecting an environmentally safe mold and mildew inhibitor. This is desirable due to the propensity for mold and mildew to grow on bamboo. If desired by the purchaser, an environmentally safe flame retardant and/or insect inhibitor may be pressure-injected.

An embodiment of the product may have the smoothness and appearance of “butcher block” wood when viewed from any angle and may be strong, safe, long lasting, and suitable for construction in place of traditional hardwood.

In an embodiment, during the manufacturing process or after cutting, milling, routing, or otherwise preparing and/or installing the products, an environmentally safe nano technology coating may be applied, the nano particles of which will penetrate and occupy the microscopic voids in and between the cells of the bamboo, thereby minimizing the intrusion of moisture and inhibiting the capillary action of the bamboo strands. The intended coating my also contain ultra-violet inhibitors to reduce any product degradation caused by exposure to sunlight. By varying the orientation of an embodiment of the bamboo strips, a high degree of strength may be achieved. Preliminary tests have shown embodiments to be suitable for use as structural lumber, surpassing the strength of existing wood, composite, and plastic decking and lumber material presently in use.

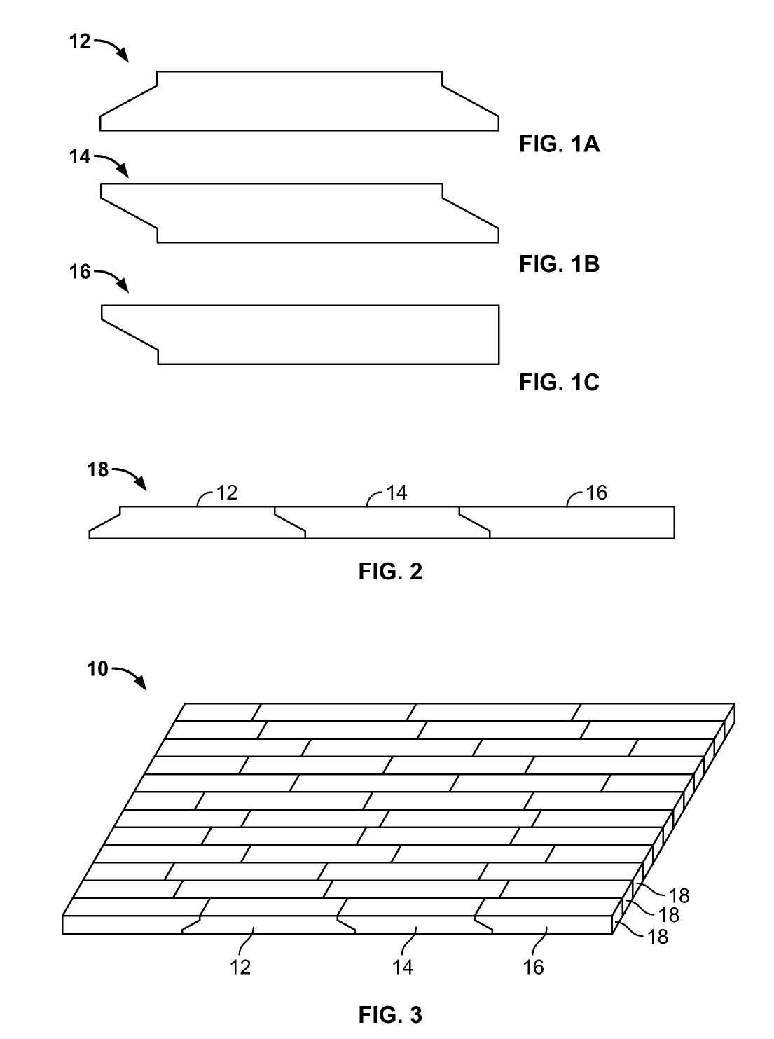

FIGS. 1A, 1B, and 1C illustrate examples of an embodiment of a bamboo lamella or strip, which may be of varying lengths, and which may have examples in different shapes. The segment 12 of FIG. 1A has been cut with a bottom overlap for joining. The left end of the segment 14 of FIG. 1B has been cut with a top overlap for joining. The left end of the segment 16 of FIG. 1C has been cut with a top overlap and the right end remains blunt.

The embodiment of FIG. 2 illustrates the three bamboo segments 12, 14, and 16 joined together in one possible combination of joints to form a jointed strip 18. The strips may have varying lengths, but the strips have substantially the same width and depth.

The embodiment of FIG. 3 illustrates a view of a bamboo board or single-layer panel, illustrated in a horizontal orientation, where multiple joined bamboo lamellas have been laminated together to achieve the width. The strips may have a long axis or major axis that runs the length of the strip, with two ends at the extremes of the long axis, a width from side to side of the strip, and a depth or height between the top and bottom that may be relatively thin. The “top” and “bottom” are not necessarily up and down, but are the opposing surfaces that are separated by the depth of the grass. The example of FIG. 3 shows strips connected side-to-side in a horizontal orientation that may be wide, but relatively thin. Varying the vertical thickness, length, and number of lamellas permits a variety of possible resulting dimensions.

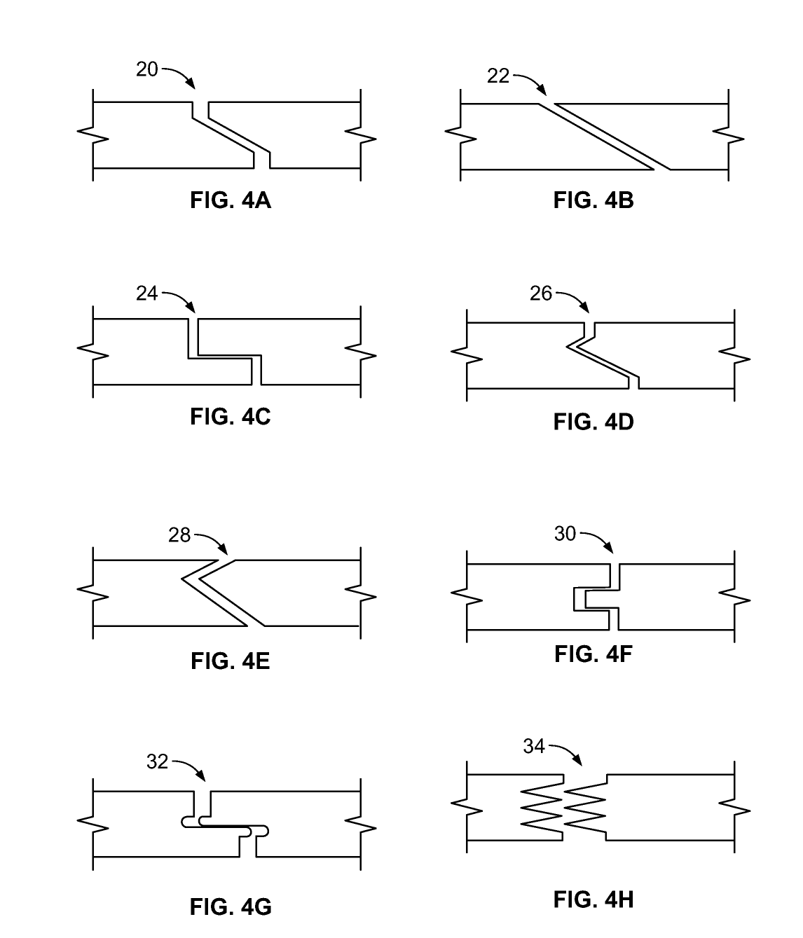

FIGS. 4A through 4H illustrate examples of an embodiment of a bamboo board 10 having joints that would be employed to lengthen the bamboo lamellas, which may form different lengths. The length of the lamellas may depend upon the customer's preference. FIG. 4A depicts an angled butt joint 20. FIG. 4B depicts a flat butt joint 22. FIG. 4C depicts an overlap butt joint 24. FIG. 4D depicts a single zigzag butt joint 26. FIG. 4E depicts a V-style butt joint 28. FIG. 4F depicts a tongue-and-groove butt joint 30. FIG. 4G depicts a double tongue-and groove butt joint 32. FIG. 4H depicts a multi-zigzag butt joint 34.

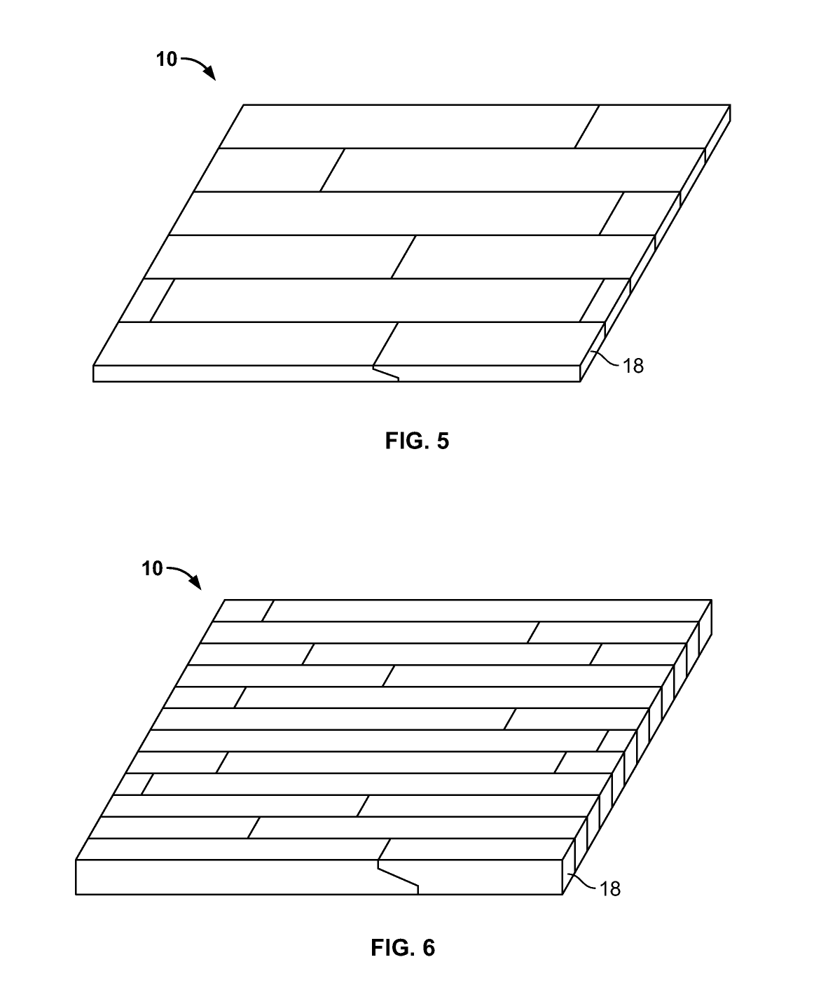

The examples of FIGS. 5 and 6 illustrate embodiments of panels or single-layer boards. FIG. 5 illustrates a single-layer panel where the strips are oriented horizontally, connected side-to-side to provide width. The top and bottoms of the strips become the top and bottom of the panel, so the depth of the panel is equal to the depth of the strips. FIG. 6 illustrates a single-layer panel where the strips are oriented vertically, connected top-to-bottom to provide depth for increased strength. The sides of the strips may become the top and bottom of the panel, so the depth of the panel is equal to the width of the strips. The panels may have a “direction” in that the strips in a panel may be parallel, with their long axes aligned in a single direction.

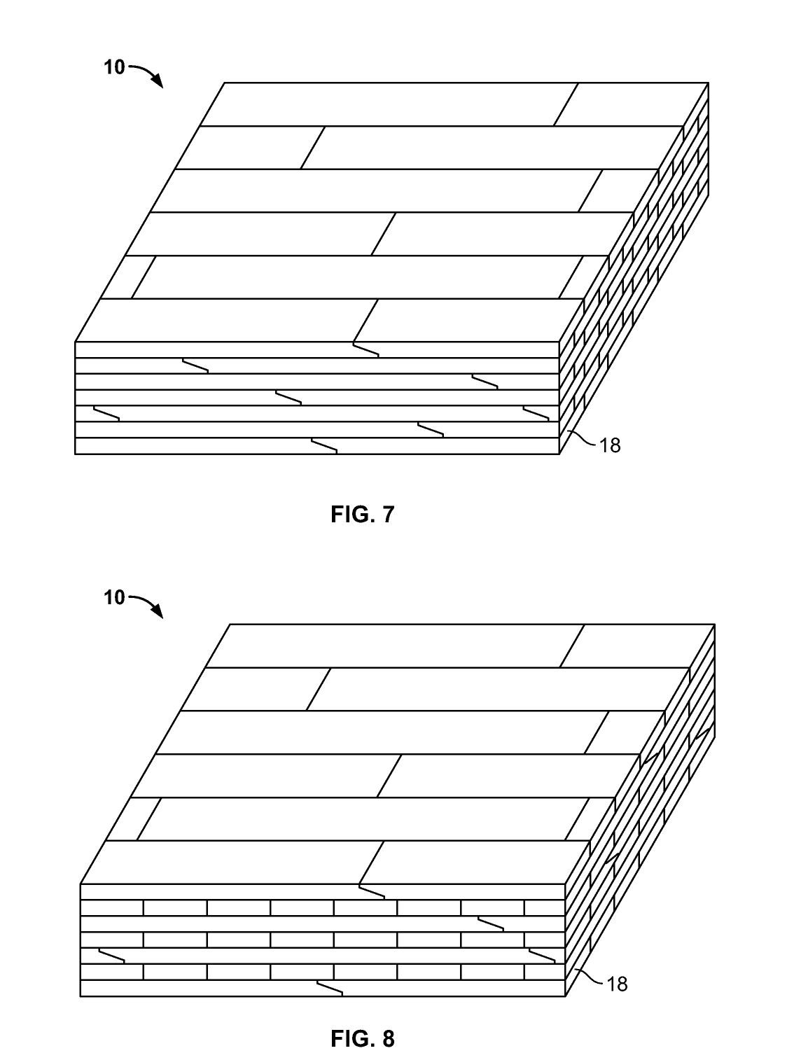

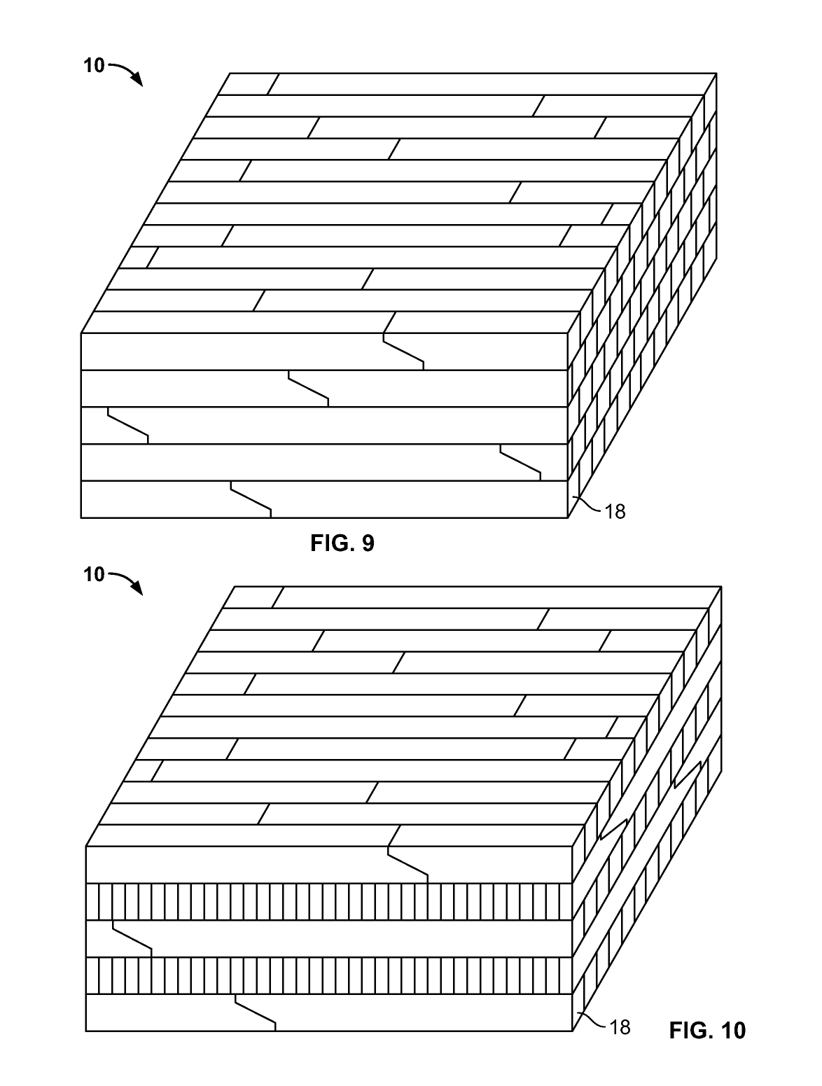

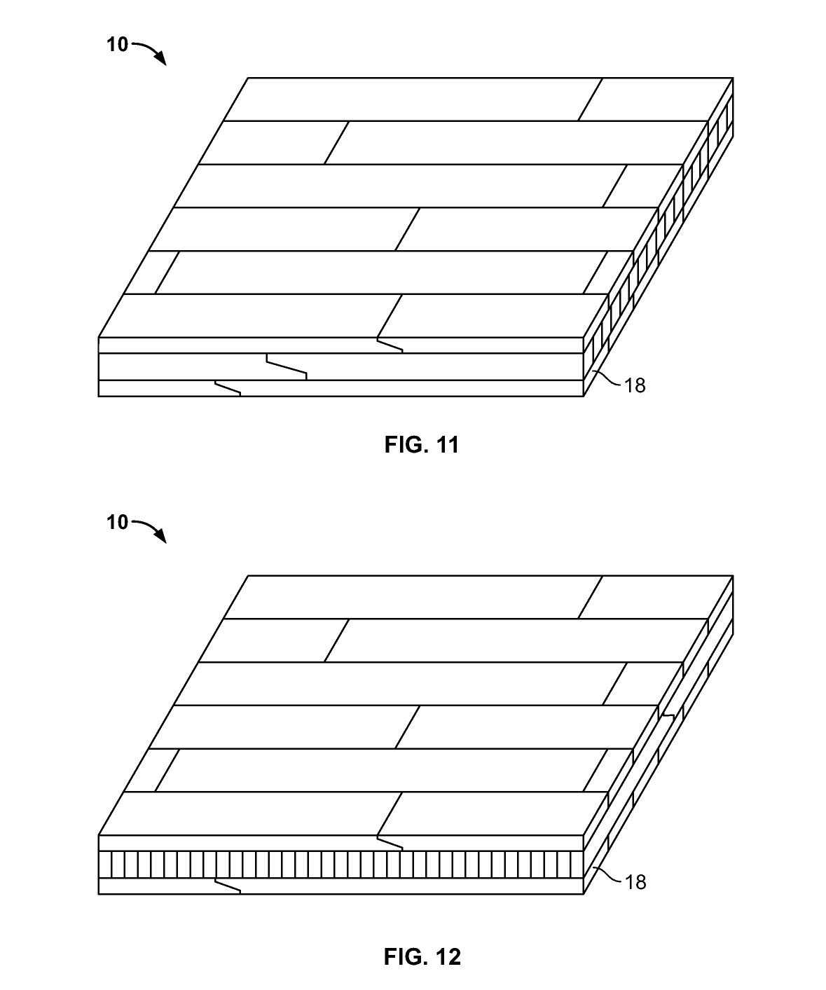

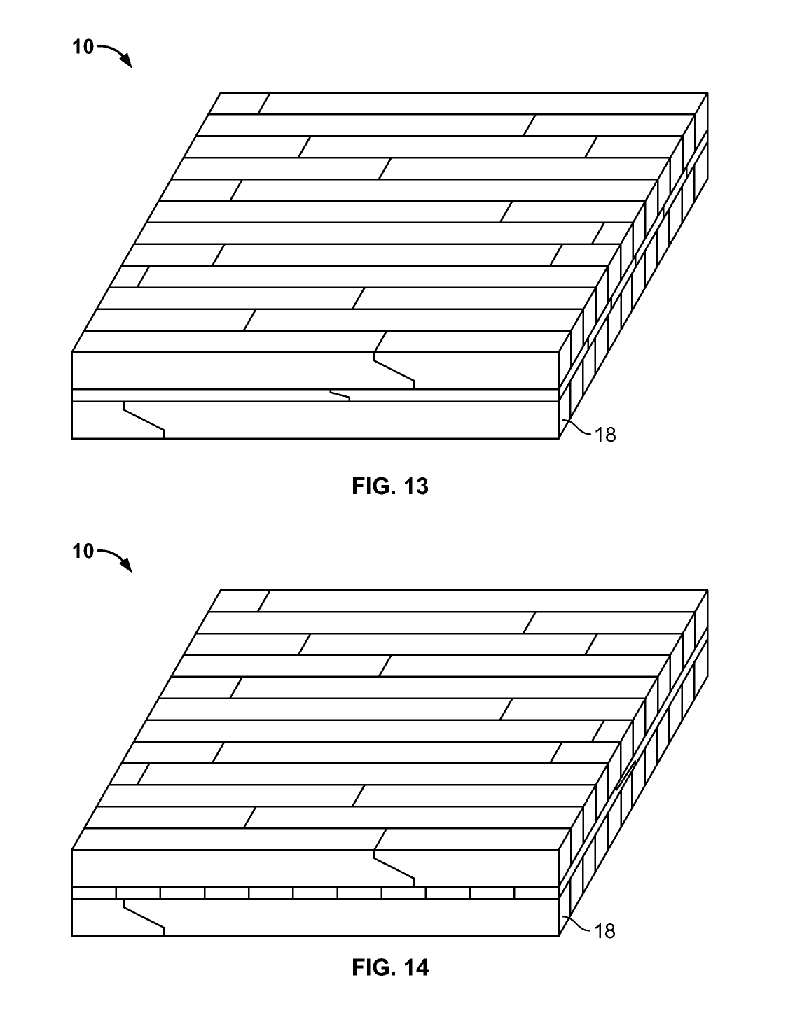

The examples of FIGS. 7 through 14 illustrate embodiments of multi-layer boards. The panels of FIGS. 5 and 6 may be layers to create a board. FIG. 7 illustrates a multi-layer board with the strips oriented horizontally and all in the same direction. FIG. 8 illustrates a multi-layer board with the strips oriented horizontally with the strips of each layer alternating ad different angles, such as in 90 degree or perpendicular opposition. FIG. 9 illustrates multi-layer board with the strips oriented vertically and all in the same direction. FIG. 10 illustrates a multi-layer board with the strips oriented vertically with the strips of each layer alternating in 90 degree opposition. FIG. 11 illustrates a board where each layer alternates between horizontal and vertical orientation with all strips in the same direction. FIG. 12 illustrates a board where each layer alternates between horizontal and vertical orientation and the strips of each layer alternating in 90 degree opposition. The outside of the examples of FIGS. 11 and 12 are horizontal. FIGS. 13 and 14 illustrate examples of boards where each layer alternates between horizontal and vertical orientation, with the outside layer vertical.

Embodiments of the present invention include the use of solid bamboo lamellas laminated in various configurations with exterior-grade, environmentally safe adhesive to create lumber and decking products for interior or exterior structural and general construction use.

In embodiments of the claimed invention, the lumber or decking material may be impregnated or coated with any or all of the following: mold and mildew inhibitor, fire retardant, insect inhibitor, nano-technology sealants or coatings. Embodiments of the claimed invention include lengthening the bamboo lamellas to a practical size by the use of any of the illustrated or similar joint techniques. Embodiments of the claimed invention may include varying the orientation of the bamboo lamellas in layers in order to achieve a high degree of strength and stiffness. Such variations may include vertical vs. horizontal orientation or any combination thereof, and orientating layers of lamellas by varying the direction of the angles employed.

Embodiments of the claimed invention include manufacturing lumber and decking products of a desired length, width, or thickness by arranging or stacking the lamellas during the lamination process to achieve the desired configuration and dimensions.

To make an embodiment, bamboo may be harvested, cut to manageable lengths, and kiln-dried to remove excess moisture and to kill any insects or mold spores. The bamboo stalks may then be sliced into rectangular lamellas (strips). The short lamellas may then be then joined into longer length lamellas using various joining techniques and assembled into slightly oversized configurations for lumber (e.g. 2″×4″) and laminated using an environmentally safe exterior grade adhesive. A final shaping and sanding step may then be performed, which helps insure conformance to the desired sizes. The product is impregnated with an environmentally safe mold/mildew inhibitor and (if desired), an environmentally safe fire retardant.

In an embodiment, the steps are performed in the order listed. The raw material bamboo is kiln dried. The lamellas may be cut to the same size for production use. The assembly of the lamellas may conform to the desired resultant lumber size in all three dimensions. The lamination process may cause the lamellas to adhere to each other in the configuration desired. An embodiment includes addition of an optional anti-mold/mildew and fire retardant, which may be last.

Embodiments may be made utilizing a high heat/pressure laminator, precision saws and sanders.

Embodiments of lumber, decking, or other building materials in various dimensions may include one or more layers of uniform long length jointed solid bamboo lamellas laminated in various orientations using environmentally safe exterior grade adhesive to create a structurally strong substitute for traditional wood products. The building materials may be impregnated with an environmentally safe mold and mildew inhibitor, an environmentally safe fire retardant, an environmentally safe insect inhibitor, or an environmentally safe nano-technology coating to inhibit moisture and ultra-violet damage. The building materials may be situated in a parallel pattern relative to one another, situated perpendicular to each other, or situated at any angle relative to one another.

Embodiments may include methods of lengthening bamboo lamellas by joining said lamellas end-to-end with suitable joining techniques to create any length desired, by varying the quantity and orientation of jointed or unjointed bamboo lamellas to achieve the desired dimensions, or by varying the quantity and orientation of bamboo lamellas to achieve the desired dimensions.

In other embodiments, the principles applied to bamboo could be applied to other grasses having structural strength.

I claim:

1. A building material comprising:
a first segment of a grass;
a second segment of the grass; and
a first joint element in the first segment that engages with a corresponding second joint element in the second segment, so that the segments form a strip.

2. The building material of claim 1, wherein the grass is bamboo.

3. The building material of claim 1, wherein the segments have substantially the same width and depth.

4. The building material of claim 1, wherein the segments each have a long axis and the joint elements are located at the ends of the long axes so that the segments are joined end-to-end.

5. The building material of claim 1, further comprising:
a plurality of strips, attached together to form a panel.

6. The building material of claim 5, each strip having sides, wherein the strips are attached together side-to-side.

7. The building material of claim 5, each strip having a top and bottom, wherein the strips are attached together top-to-bottom.

8. The building material of claim 5, wherein the strips are laminated together with an exterior grade, low formaldehyde, low-urea-content adhesive.

9. The building material of claim 1, further comprising:
a first strip, having a first segment with a first length, the first segment joined to a second segment;
a second strip, having a third segment with a second length, the third segment joined to a fourth segment;
wherein the first strip is attached to the second strip so as to form a panel; and
the first length differs from the second length so that the joint positions in the panel are non-adjacent.

10. The building material of claim 1, further comprising:
a first plurality of strips attached together to form a first panel; and
a second plurality of strips attached together to form a second panel;
wherein the first panel is attached to the second panel so as to form a board.

11. The building material of claim 1, further comprising:
a first plurality of strips attached together in parallel to form a first panel having a first direction; and
a second plurality of strips attached together in parallel to form a second panel having a second direction;
wherein the first panel is attached to the second panel so as to form a board; and
the panels are aligned so that the first and second directions form a non-zero angle.

12. The building material of claim 11, wherein the direction of the strips in the panels are substantially perpendicular to each other.

13. The building material of claim 1, further comprising:
an additive selected from the group consisting of: mold and mildew inhibitor, fire retardant, insect inhibitor, or sealant.

14. A board comprising:
a plurality of bamboo segments, joined together end-to-end with joint elements to form strips;
a plurality of strips, attached together to form panels; and
a plurality of panels, attached together to form the board;
wherein the strips and panels are laminated together with an exterior grade, low formaldehyde, low-urea-content adhesive.

15. The board of claim 14, wherein:
the joint elements in the strips form joint positions, and the lengths of the bamboo segments differ so that the joint positions in adjacent strips do not line up.

16. The board of claim 14, wherein the panels are aligned so that the strips in adjacent panels are in different directions.

17. A method of making a building material from a grass, comprising:
joining segments of the grass together to form a plurality of strips;
arranging the strips to achieve a desired dimension; and
utilizing laminating the strips together.

18. The method of claim 17, further comprising:
utilizing a high-heat and high-pressure process to laminate the strips together with an adhesive.

19. The method of claim 17, further comprising:
varying the lengths of the segments of grass so as to help prevent joints in the strips from being adjacent to one another in the building material.

20. The method of claim 17, wherein the grass is bamboo, the method further comprising:
drying the bamboo to remove excess moisture and to kill insects and mold; and
cutting the bamboo to form the segments.
